(19) United States
(12) Patent Application Publication
(10) Pub. No.: US 2007/0071958 A1
(43) Pub. Date: Mar. 29, 2007

(54) Composite synthetic resin composition and material therefrom

(75) Inventor: Haruki Kobata, Kanagawa (JP)

Correspondence Address: NORRIS, MCLAUGHLIN & MARCUS, P.A., 875 THIRD AVE, 18TH FLOOR, NEW YORK, NY, 10022, US

(73) Assignee: AMTEC INC., Tokyo (JP)

(21) Appl. No.: 10/595,949

(22) PCT Filed: Nov. 4, 2004
(86) PCT No.: PCT/JP04/16775

§ 371 Date: May 22, 2006

(30) Foreign Application Priority Data
Nov. 25, 2003 (JP) 2003-393209

(51) Int. Cl. B32B 27/04; C08K 7/02; B32B 37/00

(52) U.S. Cl. 428/297.4; 428/332; 525/935

(57) ABSTRACT

A liquid composite synthetic resin composition that can strike a balance between miscibility with aggregate and compaction performance of the mixture and that can form a shielding film capable of shielding X rays or radiation from cobalt 60 radiation source or a strong water-permeable/retentive film in spaces formed between aggregate particles. Further, there is provided a composite synthetic resin composition produced by adding, to a liquid synthetic resin, inorganic or organic fiber filaments having a length of 1 micron to 500 microns sequentially in the order of increasing length in an amount of 1 wt. % to 15 wt. % with respect to the resin, and mixing the fiber filaments with the resin, so that the resin is adsorbed onto the fiber filaments; and by adding, to the liquid synthetic resin, inorganic or organic fiber filaments having a diameter of 3 microns to 900 microns and a length of 1 mm to 50 mm sequentially in the order of increasing length in an amount of 1 wt. % to 10 wt. % with respect to the resin, and mixing the fiber filaments with the resin, so that the resin is adsorbed onto the fiber filaments.

### TECHNICAL FIELD

The present invention relates to a composite synthetic resin composition having adhesive property, and to a material containing the composition.

### BACKGROUND ART

Recently, in the fields of civil engineering, architecture, and the like, synthetic resins have often been employed as aggregate adhesives, in place of cement or asphalt which has conventionally been used as an aggregate adhesive.

Synthetic resins include a liquid synthetic resin which is mixed with a solvent and employed in liquid form, and a synthetic resin which is employed in powder form. Applications of synthetic resins, which respectively have unique hardening effects, are determined on the basis of their physical properties; for example, a liquid synthetic resin is admixed and kneaded with an aggregate, to thereby produce a pavement material or a block material.

In the case of an adhesive to be employed in the field of civil engineering, architecture, or the like, both miscibility and compaction performance must be satisfied; i.e., miscibility of the adhesive with an aggregate and compaction performance of the resultant mixture. However, an adhesive of high viscosity fails to attain good miscibility with an aggregate, whereas an adhesive of low viscosity having good miscibility fails to form a mixture exhibiting high compaction performance.

Particularly in the case where a liquid synthetic resin is employed as an adhesive, since installation is generally performed at ambient temperature, compaction operation can be performed only within a short period of time when the initial hardening of the liquid synthetic resin starts. When compaction operation is continued during the course of hardening of the liquid synthetic resin, a portion which begins to harden is further compacted, which often leads to breakage of a portion of the resin which has already been hardened.

However, the miscibility of a liquid synthetic resin which has conventionally been employed as an adhesive varies greatly with the environmental temperature of installation (hereinafter referred to as installation temperature), and thus the miscibility depends only on the viscosity level of the liquid synthetic resin. Therefore, in order to enhance compaction performance, the viscosity of the liquid synthetic resin must be regulated in accordance with installation temperature.

Specifically, a liquid synthetic resin having low viscosity can be uniformly mixed with an aggregate even at a low installation temperature, but the resultant mixture, which has low viscosity, fails to attain sufficient compaction performance. The strength of a mixture of an adhesive and an aggregate, such as a pavement material, is determined on the basis of the strength and stability of the aggregate. An adhesive which cannot provide sufficient compaction performance fails to sufficiently establish the stability of an aggregate to be employed, and therefore, a mixture exhibiting sufficient strength fails to be obtained. For example, when a dense graded aggregate is incorporated into a liquid synthetic resin, stone powder or fine sand forms lumps, and thus sufficient compaction performance fails to be attained.

Needless to say, when the viscosity of a liquid synthetic resin is increased so as to enhance compaction performance, the resin exhibits poor miscibility with an aggregate, possibly causing separation or falling, or “topping,” of aggregate particles.

In a water-permeable/drainage material or a similar material produced through use of a liquid synthetic resin serving as an adhesive, so-called point-to-point contact is established between aggregate particles, where the liquid synthetic resin is deposited and solidified, and the hardened and solidified resin is embedded in spaces between the aggregate particles.

The water-permeability of such a water-permeable/drainage material depends on spaces formed between aggregate particles, and the spaces are prone to be stuffed with soil and sand, dust, or the like. Therefore, excess force is applied to the hardened and solidified resin, resulting in separation or falling of the aggregate particles.

In connection with such problems, in order to satisfy both the miscibility of a liquid synthetic resin with an aggregate and the compaction performance of the resultant mixture, the present inventor proposed a method for mixing a liquid synthetic resin with fiber filaments having a length of 1 mm or more, thereby enhancing the apparent viscosity of the liquid synthetic resin (Japanese Patent No. 3145353).

However, when the apparent viscosity of the liquid synthetic resin alone is regulated by adding fiber filaments having a length of 1 mm or more to the resin in consideration of the viscosity level of the resin, the liquid synthetic resin fails to be completely adsorbed onto the fiber filaments, and non-adsorbed liquid synthetic resin remains in the mixture, resulting in failure to simultaneously achieve satisfactory miscibility and compaction performance. Meanwhile, increasing the amount of fiber filaments having a length of 1 mm or more raises a problem of, for example, poor miscibility due to entanglement of the fiber filaments.

Also, there has not yet been solved a problem that, for example, the non-adsorbed liquid synthetic resin, which remains in the mixture, enters the spaces formed between aggregate particles to thereby form a thin film, and thus the resultant pores are stuffed with soil and sand, dust, or the like during water permeation, thereby causing separation or falling of the aggregate particles.

### DISCLOSURE OF THE INVENTION

In view of the foregoing, the present invention provides a composite synthetic resin composition which is produced by adding, to a liquid synthetic resin, inorganic or organic fiber filaments having a length of 1 micron to 500 microns in an amount of 1 wt. % to 15 wt. % with respect to the resin, and mixing the fiber filaments with the resin, so that the resin is adsorbed onto the fiber filaments; and by adding, to the liquid synthetic resin, inorganic or organic fiber filaments having a diameter of 3 microns to 900 microns and a length of 1 mm to 50 mm in an amount of 1 wt. % to 10 wt. % with respect to the resin, and mixing the fiber filaments with the resin, so that the resin is adsorbed onto the fiber filaments.

Specifically, the present invention also provides a composite synthetic resin composition which is produced by adding, to a liquid synthetic resin, inorganic or organic fiber filaments having a length of 1 micron to 500 microns sequentially in the order of increasing length in an amount of 1 wt. % to 15 wt. % with respect to the resin, and mixing the fiber filaments with the resin, so that the resin is adsorbed onto the fiber filaments; and by adding, to the liquid synthetic resin, inorganic or organic fiber filaments having a diameter of 3 microns to 900 microns and a length of 1 mm to 50 mm sequentially in the order of increasing length in an amount of 1 wt. % to 10 wt. % with respect to the resin, and mixing the fiber filaments with the resin, so that the resin is adsorbed onto the fiber filaments.

In the present invention, a liquid synthetic resin of low viscosity is bonded, through adsorption, to fiber filaments having a size on the order of micron, and the thus-stabilized liquid synthetic resin is bonded, through adsorption, to fiber filaments having a length of 1 mm or more.

Therefore, in the present invention, the liquid synthetic resin which has not been adsorbed onto fiber filaments does not remain in the resin-fiber mixture. Thus, the composite synthetic resin composition of the present invention can exhibit sufficient miscibility with an aggregate, and the resultant mixture can exhibit high compaction performance.

According to the present invention, in the case where a liquid synthetic resin having an initial viscosity of 800 cps to 1,500 cps is employed, even when, for example, installation is performed at a temperature of −5° C., uniform miscibility can be attained.

Even when the installation temperature exceeds 30° C. to 40° C., sufficient compaction performance can be attained.

In the present invention, even when an aggregate of small particle size is incorporated into a liquid synthetic resin, neither stone powder nor fine sand forms lumps. Specifically, No. 7 crushed stone having a particle size of 2 mm to 8 mm, No. 6 crushed stone having a particle size up to 30 mm, or No. 5 crushed stone having a particle size up to 40 mm was able to be uniformly mixed with a liquid synthetic resin at low temperature.

According to the present invention, spaces formed between aggregate particles are filled with the liquid synthetic resin, which is bonded, through adsorption, to fiber filaments having a micron-order size and is provided around frames formed by fiber filaments having a length of 1 mm or more, whereby a film having appropriate water retentivity and water permeability is formed.

The aforementioned film, which is formed by filling spaces between aggregate particles with the liquid synthetic resin which is bonded, through adsorption, to fiber filaments having a micron-order size and is provided around frames formed by fiber filaments having a length of 1 mm or more, is strong and does not raise clogging, and thus can exhibit water permeability and water retentivity over a long period of time.

According to the present invention, when the amount of the liquid synthetic resin composition to be employed and the type of fiber to be employed are appropriately determined, a film capable of shielding X rays and other radiation from a cobalt 60 radiation source can be formed between aggregate particles.

The length of the micron-order-size fiber filaments to be employed in the present invention is selected from a range of 1 micron to 500 microns in accordance with the physical properties of the liquid synthetic resin.

In accordance with the application of the resin composition, the liquid synthetic resin to be employed in the present invention is selected from among, for example, epoxy synthetic resin, urethane synthetic resin, polyurethane synthetic resin, vinyl ester synthetic resin, polyester synthetic resin, acrylic synthetic resin, and phenolic synthetic resin.

In accordance with the application of the resin composition, the fiber to be employed in the present invention is selected from among strong fiber species which are incompatible with the liquid synthetic resin; for example, silica fiber, glass fiber, ceramic fiber, carbon fiber, nylon fiber, polyester fiber, vinyl fiber, and epoxy fiber. In the conventional method, a liquid synthetic resin is unstably adsorbed onto fiber filaments having a length of 1 mm or more. In contrast, when a liquid synthetic resin is adsorbed onto fiber filaments of micron-order size and then onto fiber filaments of 1 mm or more, stable resin adsorption is attained, whereby both miscibility and compaction performance can be satisfied, and the performance and function of the liquid synthetic resin are fundamentally improved.

The present invention can significantly expand the range of fields to which a liquid synthetic resin is applied, and can compensate for problems involved in conventionally employed cement or asphalt.

### BRIEF DESCRIPTION OF THE DRAWING

FIG. 1 is a schematic representation enlargedly showing the water-permeable/retentive film formed from the composite synthetic resin composition of the present invention, the film being formed in spaces formed between aggregate particles. In FIG. 1, reference letter A denotes aggregate particles; B liquid synthetic resin adsorbed onto fiber filaments of micron-order size; C liquid synthetic resin adsorbed onto fiber filaments having a length of 1 mm or more; and D ultrafine pores formed in the liquid synthetic resin composition.

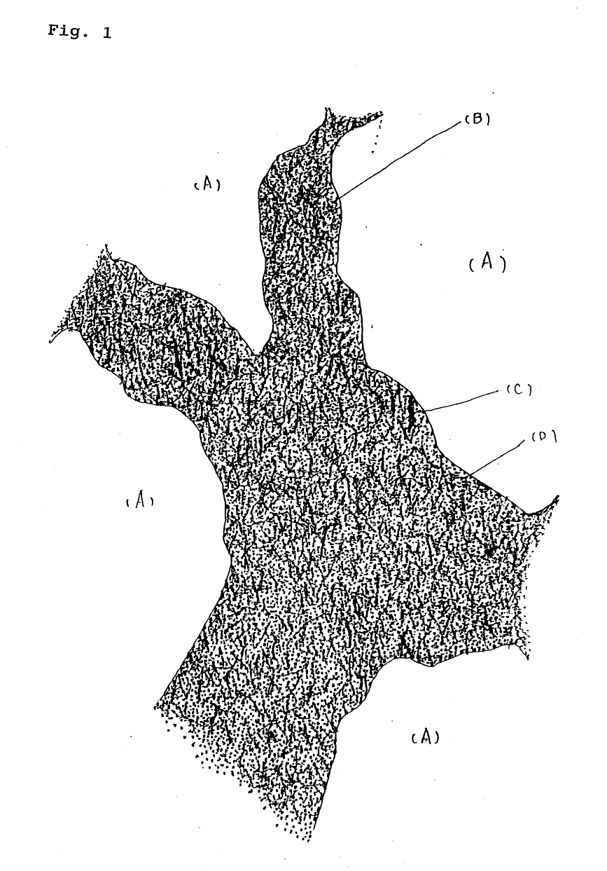

### BEST MODE FOR CARRYING OUT THE INVENTION

Examples of use of the composite synthetic resin composition of the present invention include a molding material for containers and the like, which is obtained by mixing the composition with, for example, waste cement/concrete material, waste asphalt/concrete material, incinerated ash, molten chips, sludge, seashell, volcanic ash, crushed mineral, or iron and steel slag; a pavement material for roads and the like, which is obtained by mixing the composition with, for example, dense-graded or coarse-graded aggregate, sand, gravel, waste plastic chips, glass chips, tire chips, molten chips, iron and steel slag, pottery chips, tile chips, crushed mineral, soil, chaff, wood chips, volcanic ash, incinerated ash, or seashell; a molding material for blocks, which is obtained by mixing the composition with, for example, sand, gravel, waste plastic chips, glass chips, waste tire chips, molten chips, iron and steel slag, pottery chips, tile chips, crushed mineral, soil, chaff, wood chips, volcanic ash, incinerated ash, or seashell; a molding material for revetment materials, fish reef materials, and the like, which is obtained by mixing the composition with, for example, waste tire chips, molten chips, iron and steel slag, pottery chips, tile chips, crushed mineral, or soil; a slate or a lightweight, strong soundproofing or heat-insulating material, which is obtained by mixing the composition with, for example, waste tire chips, tile chips, shredder dust, or metal chips; a molding material for concrete panels, which is obtained by mixing the composition with, for example, shredder dust, polystyrene foam, or shredded paper; an erosion control or retaining wall material, which is obtained by mixing the composition with, for example, crushed stone, sand, or iron and steel slag; a tile or terrazzo material obtained by mixing the composition with, for example, sludge, marble chips, volcanic ash, incinerated ash, or molten chips; a molding material for planters or flowerpots, which is obtained by mixing the composition with, for example, gravel, crushed stone, waste plastic chips, volcanic ash, pottery chips, tile chips, chaff, shredder dust, shredded paper, or wood chips; a molding material for window frames or other building materials, which is obtained by mixing the composition with, for example, waste aluminum chips, zeolite, heal stone chips, fossil chips, or charcoal; a landscaping or gardening material obtained by mixing the composition with, for example, zeolite, volcanic ash, or incinerated ash; a molding material for culverts, which is obtained by mixing the composition with, for example, crushed stone or sand; and a molding material for rainwater treatment blocks, which is obtained by mixing the composition with, for example, crushed stone or sand.

The composite synthetic resin composition of the present invention may be employed as a coating material; or may be mixed with, for example, ceramic material, zeolite, or sand, and employed as a spraying or coating material for reinforcement of a cement structure.

The composite synthetic resin composition of the present invention may be employed as a coating material for blocking elution of toxic substances. Alternatively, the composition may be mixed with, for example, contaminated soil, followed by compaction and solidification, and the resultant product may be employed for preventing elution of toxic substances.

The composite synthetic resin composition of the present invention may be employed as a repairing material for fiber-reinforced plastic (hereinafter may be abbreviated as “FRP”) materials or FRP products; or may be mixed with, for example, sand, and employed as a repairing material for asphalt structures or other structures.

The composite synthetic resin composition of the present invention may be employed as a constituent base of a material for shielding or blocking X rays or radiation from a cobalt 60 radiation source, etc., or as a coating material for shielding or blocking such radiation.

In the case where a coating material is formed of the composite synthetic resin composition of the present invention, preferably, a liquid synthetic resin having a viscosity of 1,200 cps to 1,400 cps as measured at 20° C., which is employed as a base, is mixed with and adsorbed onto inorganic or organic fiber filaments having a length selected from a range of 10 microns to 50 microns, and subsequently the resin is adsorbed onto inorganic or organic fiber filaments having a diameter selected from a range of 10 microns to 50 microns and a length selected from a range of 1 mm to 3 mm.

In the case where a repairing material for FRP materials or FRP products is formed of the composite synthetic resin composition of the present invention, preferably, a liquid synthetic resin having a viscosity of 1,500 cps to 1,600 cps as measured at 20° C., which is employed as a base, is mixed with and adsorbed onto inorganic or organic fiber filaments having a length selected from a range of 7 microns to 100 microns (6 wt. % to 10 wt. % with respect to the resin), and subsequently the liquid synthetic resin is mixed with and adsorbed onto inorganic or organic fiber filaments having a diameter selected from a range of 10 microns to 100 microns and a length selected from a range of 1 mm to 100 mm (5 wt. % to 8 wt. % with respect to the resin).

In the case where a material for shielding or blocking X rays or radiation from a cobalt 60 radiation source, etc., or a coating material for shielding or blocking such radiation is formed of the composite synthetic resin composition of the present invention, preferably, a liquid synthetic resin having a viscosity of about 3,000 cps as measured at 20° C., which is employed as a base, is mixed with and adsorbed onto inorganic or organic fiber filaments having a length selected from a range of 7 microns to 20 microns (7 wt. % to 10 wt. % with respect to the resin), and subsequently the liquid synthetic resin is mixed with and adsorbed onto inorganic or organic fiber filaments having a diameter selected from a range of 7 microns to 10 microns and a length selected from a range of 1 mm to 5 mm (8 wt. % to 10 wt. % with respect to the resin).

In the case where a molding material for building materials is formed by mixing the composite synthetic resin composition of the present invention with, for example, zeolite, heal stone chips, fossil chips, or charcoal, preferably, a liquid synthetic resin having a viscosity of 1,600 cps to 2,000 cps as measured at 20° C., which is employed as a base of the resin composition, is mixed with and adsorbed onto inorganic or organic fiber filaments having a length selected from a range of 7 microns to 15 microns (3 wt. % to 7 wt. % with respect to the resin), and subsequently the liquid synthetic resin is mixed with and adsorbed onto inorganic or organic fiber filaments having a diameter selected from a range of 7 microns to 20 microns and a length selected from a range of 1 mm to 5 mm (2 wt. % to 5 wt. % with respect to the resin).

### EXAMPLES

The present invention will next be described by way of Examples.

### Example 1

An epoxy synthetic resin having a viscosity of 1,400 cps as measured at 20° C. (product of Towakasei) (50 kg) was placed in an Omni-mixer (30 L, product of Chiyoda Technical & Industrial Co., Ltd.), and silica fiber having a length of 10 microns (product of Nitivy Co., Ltd.) (500 g) was added to the mixer, followed by mixing for one minute, so that the epoxy synthetic resin was adsorbed onto the silica fiber. Subsequently, silica fiber having a length of 20 microns (product of Nitivy Co., Ltd.) (500 g) was added to and mixed with the epoxy synthetic resin for two minutes, so that the resin was adsorbed onto the silica fiber. Thereafter, polyester fiber having a diameter of 10 microns and a length of 3 mm (product of Toray Industries, Inc.) (1 kg) was added to and mixed with the epoxy synthetic resin for two minutes, so that the resin was adsorbed onto the polyester fiber, to thereby yield 53 kg of a composite synthetic resin composition which has such a viscosity that it can be mixed with a material even at a installation temperature of 0° C.

The composite synthetic resin composition obtained in this Example (50 g) was placed on a glass plate, and spread over the plate for examination.

The results of examination of a composite synthetic resin composition which was obtained by mixing a liquid synthetic resin with merely polyester fiber having a length of 1 mm or more in a manner similar to that of Example 1 reveal that spaces between frames formed by overlapped fiber filaments are filled with unadsorbed liquid synthetic resin. In contrast, the results of examination of the composite synthetic resin composition of this Example which was spread over the glass plate reveal that spaces between frames formed by overlapped polyester fiber filaments having a mm-order length are filled with liquid synthetic resin adsorbed onto silica fiber filaments having a micron-order length.

Specifically, in spaces between frames formed by overlapped fiber filaments having a mm-order length, water-permeable ultrafine pores with appropriate water retentivity are formed by fiber filaments having a micron-order length onto which the liquid synthetic resin has been adsorbed. Therefore, the present invention attains formation of a material having water permeability and water retentivity (i.e., water-permeable/retentive material) which can be employed in a variety of fields.

### Example 2

The composite synthetic resin composition obtained in Example 1 (3 kg) and flake-like waste tire chips (64 kg) were divided equally into two flat mixers, and the mixture in each of the mixers was mixed for two minutes. Subsequently, a hardening agent (600 g) was added to each of the mixers, followed by mixing for three minutes, to thereby yield a waste-tire-mixed material (total: 68.2 kg). The resultant mixed material was uniformly applied onto a subbase (1 m×1 m×30 mm) which had been provided in advance, followed by rolling compaction by means of a 1-ton iron drum roller for two minutes for pavement. Meanwhile, the waste-tire-mixed material (20.8 kg) was charged into five molds having dimensions of 300 mm×300 mm×50 mm, and the molds were subjected to stationary compaction by means of a 10-ton hydraulic machine for three minutes, to thereby yield five flat boards.

### Example 3

The composite synthetic resin composition obtained in Example 1 (4.5 kg) and sludge having a water content of 50% (75 kg) were divided equally into two flat mixers, and the mixture in each of the mixers was mixed for four minutes. Subsequently, a hardening agent (900 g) was added to each of the mixers, followed by further mixing for three minutes, to thereby yield a sludge-mixed material (total: 81.3 kg). A portion (56.3 kg) of the resultant mixed material was uniformly applied onto a subbase of 1 m×1 m×50 mm, followed by rolling compaction by means of a 1-ton iron drum roller for three minutes for pavement. Meanwhile, the remaining sludge-mixed material (25 kg) was charged into five molds having dimensions of 300 mm×300 mm×50 mm, and the molds were subjected to stationary compaction by means of a 10-ton hydraulic machine for three minutes, to thereby yield flat boards.

In Example 3, compaction with the hydraulic machine caused oozing of an unexpectedly large amount of water, but thereafter, strong hardening was attained by means of the added composite synthetic resin composition.

### Example 4

The composite synthetic resin composition obtained in Example 1 (3 kg) and shredded paper (50 kg) were divided equally into two flat mixers, and the mixture in each of the mixers was mixed for three minutes. Subsequently, a hardening agent (600 g) was added to each of the mixers, followed by mixing for two minutes, to thereby yield a mixed material (total: 54.2 kg). A portion (49.2 kg) of the resultant mixed material was uniformly applied onto a subbase of 1 m×1 m×20 mm, followed by rolling compaction by means of a 1-ton iron drum roller for two minutes for pavement. Meanwhile, the remaining mixed material (5 kg) was charged into three molds having dimensions of 300 mm×300 mm×30 mm, and the molds were subjected to stationary compaction by means of a 10-ton hydraulic machine for two minutes, to thereby yield flat boards.

### Example 5

The composite synthetic resin composition obtained in Example 1 (3 kg) and shredder dusts (60 kg) were divided equally into two flat mixers, and the mixture in each of the mixers was mixed for three minutes. Subsequently, a hardening agent (600 g) was added to each of the mixers, followed by mixing for two minutes, to thereby yield a mixed material (total: 64.2 kg). A portion (48 kg) of the resultant mixed material was uniformly applied onto a subbase of 1 m×1 m×30 mm, followed by rolling compaction by means of a 1-ton iron drum roller for two minutes for pavement. Meanwhile, another portion (12 kg) of the mixed material was charged into three molds having dimensions of 300 mm×300 mm×30 mm, and the molds were subjected to stationary compaction by means of a 10-ton hydraulic machine for three minutes, to thereby yield flat boards. The composite synthetic resin composition employed was able to be mixed with shredder dusts having various physical properties, and the resultant mixture was able to be compacted, to thereby yield strong boards.

### Example 6

The composite synthetic resin composition obtained in Example 1 (1.8 kg) and polystyrene foam chips (15 kg) were divided equally into two flat mixers, and the mixture in each of the mixers was mixed for three minutes. Subsequently, a hardening agent (0.38 kg) was added to each of the mixers, followed by mixing for two minutes, to thereby yield a mixed material (total: 17.56 kg). The resultant mixed material was charged into five molds having dimensions of 300 mm×300 mm×30 mm, and the molds were subjected to stationary compaction by means of a 10-ton hydraulic machine for three minutes, to thereby yield flat blocks.

In this Example, the resin composition was able to be mixed with polystyrene foam chips, which generally have adsorbability, at a mixing ratio similar to that in the case of crushed stone, and the resultant mixture was able to be molded into strong flat blocks.

### Example 7

The composite synthetic resin composition obtained in Example 1 (2 kg) was mixed with waste asphalt/concrete chips (40 kg) by means of a flat mixer for two minutes. Subsequently, a hardening agent (0.8 kg) was added to the resultant mixture, followed by further mixing for two minutes, to thereby yield 42.8 kg of a mixed material. The resultant mixed material was uniformly applied onto a subbase of 1 m×1 m, followed by rolling compaction by means of a 1-ton iron drum roller, to thereby yield a strong pavement product (1 m x 1 m×30 mm) exhibiting water permeability and water retentivity.

In this Example, a strong, water-permeable/retentive pavement product, which was impossible to produce from a conventional pavement material (e.g., liquid synthetic resin, cement, or asphalt), was able to be obtained by mixing the resin composition with waste asphalt/concrete chips at a mixing ratio similar to that in the case of crushed stone, and applying the resultant mixture onto a subbase, followed by rolling compaction by means of an iron drum roller.

### Example 8

The composite synthetic resin composition obtained in Example 1 (2 kg) was mixed with waste cement/concrete chips (41 kg) by means of a flat mixer for two minutes. Subsequently, a hardening agent (0.8 kg) was added to the resultant mixture, followed by further mixing for two minutes, to thereby yield 43.8 kg of a mixed material. The resultant mixed material was uniformly applied onto a subbase of 1 m×1 m, followed by rolling compaction by means of a 1-ton iron drum roller, to thereby yield a strong pavement product (1 m×1 m×30 mm) exhibiting water permeability and water retentivity.

### Example 9

The composite synthetic resin composition obtained in Example 1 (200 g) was placed in a container, and was mixed with a hardening agent (80 g), followed by mixing with an inorganic pigment (10 g). The resultant mixture was placed in a pot of an air-compressor-type spraying machine which is generally employed for coating, and then sprayed onto a veneer board (longitudinal length: 1,800 mm, lateral length: 900 mm) in a direction perpendicular to the board, which had been provided in advance and placed at a distance about 300 mm away from the spraying machine. This spraying was able to form a coating film patterned with fiber filaments of 1 mm or more contained in the composition, in which gloss was somewhat suppressed by the luster unique to the liquid synthetic resin.

In this Example, in which a nozzle having a typical size (not a particularly large size) was employed, no dripping was observed, and a coating film having a thickness of about 2 mm was able to be obtained.

After hardening of the coating film, the resultant veneer board exhibited a strength which is higher than that of a non-coated veneer board and is comparable to that of a PC board.

### Example 10

The coating material obtained in Example 9 was sprayed onto cracks generated at several locations of a cement/concrete block (300 mm×300 mm×50 mm) which had been provided in advance, thereby reinforcing the block.

### Example 11

The composite synthetic resin composition obtained in Example 1 (50 g) was mixed with crushed waste plastic chips (size: 0 mm to 3 mm), followed by mixing with a hardening agent (20 g), to thereby yield a mixed material. Separately, a cylindrical die (inner diameter: 100 mm, height: 150 mm) formed of an outer die block, an inner die block, and a bottom die block was provided in advance. The above-obtained mixed material was charged into a space (thickness: 5 mm) defined by these die blocks, followed by compression molding by means of a bamboo rod. Thereafter, the inner die block, the bottom die block, and the outer die block were sequentially removed, to thereby yield a flowerpot.

### Example 12

An epoxy synthetic resin having a viscosity of 3,000 cps as measured at 20° C. (product of Towakasei) (30 kg) was placed in an Omni-mixer (30 L, product of Chiyoda Technical & Industrial Co., Ltd.), and silica fiber having a length of 10 microns (product of Nitivy Co., Ltd.) (300 g) was added to the mixer, followed by mixing for two minutes, so that the epoxy synthetic resin was adsorbed onto the silica fiber. Subsequently, silica fiber having a length of 20 microns (product of Nitivy Co., Ltd.) (300 g) was added to and mixed with the epoxy synthetic resin for two minutes, so that the resin was adsorbed onto the silica fiber. Thereafter, silica fiber having a diameter of 10 microns and a length of 2 mm (product of Nitivy Co., Ltd.) (450 g) was added to and mixed with the epoxy synthetic resin for two minutes, so that the resin was adsorbed onto the silica fiber. Subsequently, polyester fiber having a diameter of 10 microns and a length of 3 mm (product of Toray Industries, Inc.) (450 g) was added to and mixed with the epoxy synthetic resin, so that the resin was adsorbed onto the polyester fiber, to thereby yield 31.5 kg of a composite synthetic resin composition. In this case, the final mixing/adsorption required three minutes for complete dispersion of all the fiber filaments.

### Example 13

The composite synthetic resin composition obtained in Example 12 (3 kg) was mixed with marble chips (size: 0 mm to 5 mm) (30 kg) by means of a flat mixer for three minutes, followed by mixing with a hardening agent (1.2 kg), to thereby yield 34.2 kg of a mixed material. The resultant mixed material was charged into five molds having dimensions of 300 mm×300 mm×50 mm, followed by compaction by means of a 15-ton hydraulic machine, to thereby yield flat blocks. The flat blocks were cured at ambient temperature for 24 hours, and then polished, to thereby yield five terrazzo blocks.

### Example 14

The composite synthetic resin composition obtained in Example 12 (200 g) was mixed with a hardening agent (80 g), and the resultant mixture was charged into a mold having dimensions of 100 mm×100 mm×10 mm, followed by compaction by means of a 10-ton hydraulic machine, to thereby form a test piece for testing X-ray shielding performance.

The test piece formed in Example 14 was subjected to the below-described test according to JIS Z4501. The results are shown below.

Test date: August 28, 2002

Test location: Tokyo Metropolitan Industrial Technology Research Institute

Test conditions:

X-ray apparatus: MG-161 (product of Philips, smoothing circuit, focal size: 3.0 mm, Be window)

X-ray tube voltage and tube current: MG-161, 100 kv, about 10 mA, filter: 0.26 mmCu

X-ray tube voltage and tube current: MG-161, 150 kv, about 10 mA, filter: 0.70 mmCu

Distance between X-ray focal point and test tube: 1,500 mm

Distance between X-ray focal point and measuring apparatus: 50 mm

Measuring apparatus: ionization chamber-type exposure rate meter (model: RAMTEC-1000, product of Toyo Medic Co., Ltd., A-4 probe employed) X-ray beam: narrow

TABLE 1

| Product name | | | | |
|---|---|---|---|---|
| Rating | Seinterasurejin | | | |
| or specification | RF8 | RJ4 | RJ8 | RJ12 |
| Tube voltage | Less than | Less than | Less than | Less than |
| (100 kv) | 0.05 mmPb | 0.05 mmPb | 0.05 mmPb | 0.05 mmPb |
| Tube voltage | Less than | Less than | Less than | 0.05 ± |
| (150 kv) | 0.05 mmPb | 0.05 mmPb | 0.05 mmPb | 0.01 mmPb |

The results of this Example revealed that employment of the composite synthetic resin composition of the present invention attains production of an X-ray shielding product, which has been impossible to produce from a conventional material such as liquid synthetic resin, cement, or asphalt.

### Example 15

The composite synthetic resin composition obtained in Example 12 (3 kg) was mixed with silica fibers (length: 10 microns and 20 microns, products of Nitivy Co., Ltd.) (1.92 g each) and with polyester resins (diameter: 10 microns, length: 2 mm and 5 mm, products of Toray Industries, Inc.) (30 g each), so that the resin composition was adsorbed onto these fibers, to thereby yield 3,063.84 g of a composite synthetic resin composition. The resultant resin composition was charged into a mold having dimensions of 300 mm×300 mm×30 mm, followed by compaction by means of a 10-ton hydraulic machine, to thereby form a test piece for testing performance of shielding cobalt 60 radiation source.

Test conditions for the test piece formed in Example 15 and the test results are shown below.

Test date: October 1, 2002

Test location: Tokyo Metropolitan Industrial Technology Research Institute

Test method: The test piece (30 cm×30 cm×3 cm) or a lead plate (30 cm×30 cm, thickness: 1.0, 1.5, 2.0, 3.0 mm) is placed between a cobalt 60 radiation source commated with a lead shielding material (10 mm) and a detection unit of a sievert meter, and 1 cm dose equivalent rate at the center of the test piece or lead plate was measured 10 times at intervals of 30 seconds. The lead equivalent of the test piece with respect to cobalt 60 7-rays (1.173, 1.333 MeV) was determined through comparison of the measurement results.

Radiation source: cobalt 60 radiation source

Measuring apparatus: sievert meter, ALOKA DRM301S. N. J 94.002523

Measurement results

Measurement sample: the test piece

Lead equivalent (cobalt 60): 2.2 mmPb

The results of this Example revealed that employment of the composite synthetic resin composition of the present invention attains production of a product capable of shielding radiation from a cobalt 60 radiation source, which product has been impossible to produce from a conventional material such as liquid synthetic resin, cement, or asphalt. In Examples 14 and 15, employment of a liquid synthetic resin of higher viscosity (e.g., a liquid synthetic resin having an initial viscosity of 3,000 cps) can further enhance performance of shielding X-rays or other radiation.

### INDUSTRIAL APPLICABILITY

Conventionally, a liquid synthetic resin has been unstably adsorbed onto fiber filaments having a length of 1 mm or more. In contrast, according to the present invention, since a liquid synthetic resin is adsorbed onto fiber filaments of micron-order size and then onto fiber filaments of 1 mm or more, stable resin adsorption is attained, whereby both miscibility and compaction performance can be satisfied, and the performance and function of the liquid synthetic resin are fundamentally improved. That is, the present invention can significantly expand the range of fields to which a liquid synthetic resin is applied, and can compensate for problems involved in conventionally employed cement or asphalt.

1. A composite synthetic resin composition characterized in that the composition is produced by adding, to a liquid synthetic resin, inorganic or organic fiber filaments having a length of 1 micron to 500 microns in an amount of 1 wt. % to 15 wt. % with respect to the resin, and mixing the fiber filaments with the resin, so that the resin is adsorbed onto the fiber filaments; and by adding, to the liquid synthetic resin, inorganic or organic fiber filaments having a diameter of 3 microns to 900 microns and a length of 1 mm to 50 mm in an amount of 1 wt. % to 10 wt. % with respect to the resin, and mixing the fiber filaments with the resin, so that the resin is adsorbed onto the fiber filaments.

2. A composite synthetic resin composition characterized in that the composition is produced by adding, to a liquid synthetic resin, inorganic or organic fiber filaments having a length of 1 micron to 500 microns sequentially in the order of increasing length in an amount of 1 wt. % to 15 wt. % with respect to the resin, and mixing the fiber filaments with the resin, so that the resin is adsorbed onto the fiber filaments; and by adding, to the liquid synthetic resin, inorganic or organic fiber filaments having a diameter of 3 microns to 900 microns and a length of 1 mm to 50 mm sequentially in the order of increasing length in an amount of 1 wt. % to 10 wt. % with respect to the resin, and mixing the fiber filaments with the resin, so that the resin is adsorbed onto the fiber filaments.

3. A material comprising a composite synthetic resin composition as recited in claim 1 or 2, the material being a molding material for containers or the like; a pavement material for roads or the like; a molding material for blocks; a molding material for revetment materials, fish reef materials, or the like; a soundproofing or heat-insulating material; a molding material for concrete panels; an erosion control or retaining wall material; a tile or terrazzo material; a molding material for planters or flowerpots; a molding material for building materials; a landscaping material; a gardening material; a molding material for culverts; a molding material for rainwater treatment blocks, which is obtained by mixing the resin composition with crushed stone, sand, or the like; a coating material; a spraying or coating material for reinforcement of a cement structure; a material for blocking elution of a toxic substance; a repairing material for a fiber-reinforced plastic material or a fiber-reinforced plastic product; a repairing material for a structure; a material for shielding or blocking X rays or radiation from a cobalt 60 radiation source or the like source; or a similar material.
